(19) United States
(12) Patent Application Publication
(10) Pub. No.: US 2018/0000234 A1
(43) Pub. Date: Jan. 4, 2018

(54) Universal Attachment Clip System and Method Of Use

(71) Applicant: R. Stephen White, Bozeman, MT (US)

(72) Inventor: R. Stephen White, Bozeman, MT (US)

(21) Appl. No.: 15/200,328

(22) Filed: Jul. 1, 2016

(51) Int. Cl. A45F 5/02; B25H 3/00

(52) U.S. Cl. CPC A45F 5/021; B25H 3/00

(57) ABSTRACT

An attachment clip assembly to provide a solution for easy removal and reattachment of accessories to a hosting member. The hosting member could include a belt, work bench wall, tool box, bucket organizer, construction trailer wall, pouch, device holder, backpack or any other embodiment that would benefit from the attachment of accessories. The attachment assembly is of easy construction and is comprised of two parts; a male receiver plate and a female attachment device that are designed to congruently connect. Any accessory that has an attachment device installed, is able to dock with a host member that has a receiver plate installed. Upon connection, a tang with a security barb is part of the attachment device, to prevent accidental detachment from the receiver plate member.

### BACKGROUND

This present invention relates generally to utility belts or any small tool or building supplies storage and carrying system. More specifically, the invention comprises an attachment clip system for detachably connecting accessories to a host member, that could include a belt, work bench wall, tool box, bucket organizer, construction trailer wall, pouch, device holder or backpack.

Utility bags and/or belt-supported pouches for carrying nails, screws, bolts and other tools are well known in the industry. Typically, a “utility belt” is a belt having a number of pouches and/or tool holders fixedly or permanently attached to the belt.

Construction workers, tradesman and the like typically use a utility belt attached about their waists to transport and maintain tools and materials at the worksite. Often tools and supplies are also stored and organized in pouches and pockets in construction trailers, on the wall above a work bench, sides of tool boxes and sides of tool buckets.

However, since no two people are alike or perform their tasks in the same way, the preferred locations, sizes and shapes of the pouches and tool holders vary according to the user and the task at hand. Accordingly, there is a need for a utility belt that can be easily modified to suit the individual and the task at hand.

Known utility belts have exhibited disadvantages in the ways pouches or other accessories are added, removed or interchanged. When removable, these elements have been inconvenient, difficult or awkward to attach or detach from the utility belt or other host member. With most utility belts, pouches are provided with loops through which the belts can be threaded. With such utility belts, pouches or receptacles can be removed only by opening the belt and sliding the pouches off either end of the belt.

The present invention allows the user to select and arrange the tools and supplies needed for a specific job, attach and/or remove the necessary pouches or accessories from the host member. The present invention will often result in a lighter tool belt due to a reduction in pouches necessary for a given job. To improve the attachment of said accessories, the present invention includes a rigid attachment assembly with male and female mating parts, that include features to prevent accidental detachment during use.

The present invention incorporates an attachment assembly to provide a reliable and quick attachment solution for easy removal and reattachment of accessories to a hosting member. It should be understood, however, that there is no intention to limit the invention to the specific accessory members listed prior, but, on the contrary, the invention is to cover all forms of accessories, fitted with an attachment device, that could be attached to a host member, fitted with a plate member.

U.S. Pat. No. 6,390,348 B1 (2002) issued to Godshaw, U.S. Pat. No. 4,923,105 (1990) issued to Snyder, U.S. Pat. No. 2006/0289585 A1 (2006) issued to Godshaw, U.S. Pat. No. 2006/0237509 A1 (2006) issued to Moore, U.S. Pat. No. 5,441,185 (1995) issued to Dragos and U.S. Pat. No. 6,481,528 (2002) issued to Antonio show early designs to utility belts that provide opportunity to attach pockets and pouches to a host belt. To attach and detach accessory pouches with this prior art requires each pouch to be slid on to the belt in the order needed. And often the prior art requires attached pouches to be removed to accommodate any re-attachment or of any new pouch or accessory.

U.S. Pat. No. 2004/0200873 A1 (2004) issued to Jones are similar to utility belts that provide opportunity to attach pockets and pouches to a host belt. This prior art requires each pouch to be slid on to the belt in the order needed and is designed for use with a principal container with large pocket. It is further designed for the limited use for electronic devices.

U.S. Pat. No. 2006/0186152 A1 (2006) issued to Williams, U.S. Pat. No. 5,597,102 (1997) issued to Saarikko, and U.S. Pat No. 2005/0115999 A1 (2005) issued to Johnson show designs of clips that attach to utility belts. The prior art include a capture member and a retention member. The designs will likely slide along utility belts and not be secured in a fixed location as often needed by users.

U.S. Pat. No. 2007/0095991 A1 (2007) issued to Fall describes a clip device that has a hook shaped mounting device for a releasable attachment to a tool belt. This prior art is designed specifically for providing a releasable clip for holding rolled blueprints.

U.S. Pat. No. 5,152,443 (1992) issued to Hagan describes a sectional belt with substantially rigid sections. Between each belt section is a hinge. Each belt section includes an outwardly directed hanger for connecting an accessory member. This prior art, though padded, would not provide the comfort of a typical belt. The strength of the belt would be wholly dependent upon the durability of each hinge. The outwardly directed hangers would also be subject to debris, thus interfering with use.

U.S. Pat. No. 5,941,438 (1999) issued to Price describes a utility belt having adjustable means and strip loops, ring, hooks, and pockets for holding various small items. The utility belt of Price cannot receive standard accessories such as utility pouches or knife holders which are intended to slide onto a belt for mounting due to the various rings, hooks, or loops. And as in the prior mentioned art work, the belt must be removed from the wearer to mount or remove these types of accessories.

U.S. Pat. No. 2013/0008933 A1 (2013) issued to Clifford describes a tool belt having at least one pouch attached to a band. The tool belt of Clifford utilizes a guide and cord retractor to attach pouch(s). The prior mentioned art would likely require the removal of the tool belt to change or add pouches and would be complex to assemble on a job site.

U.S. Pat. No. 20,020,096,545 (2002) issued to Hsiung, U.S. Pat. No. 5,054,170 (1991) issued to Otrusina, 20030141329A1 (2003) issued to Huang and U.S. Pat. No. 20020170933A1 (2002) issued to Martin describe tool carrying devices with attachment clip systems that allow the accessory member to rotate while attached to host member. This prior art also includes a receiving member that has an open top that could become obstructed with debris that could ultimately interfere with use. This prior art is similar to the previous referenced prior art in the possibility of including host members that are attached with belt loops that are prone to moving laterally on the belt during use.

U.S. Pat. No. 2005/0072825 A1 (2005) issued to Barr describes modular pack system that utilizes an upper stay strap and lower stay strap. Attached members are clipped to the stay strap on the backpack or belt. The clipped member is only secured by the clip and allowed to swing as directed by gravity. This prior art is unsuitable for utility belt users who depend upon a more fixed location.

U.S. Pat. No. 2009/0078730 A1 (2007) issued to Kuny describes a utility belt attachment assembly that includes male and female connection elements. This prior art could also become obstructed with debris in the attachment assembly during use due to the open top design.

U.S. Pat. No. 6,848,605 (2002) issued to Dillenberger describes a utility belt attachment assembly that includes male and female connection elements. This prior art could also become obstructed with debris in the attachment assembly during use due to the open top design. The design also includes slender parts to the attachment element that could be subject to damage during use.

U.S. Pat. No. 2005/0242144 A1 (2005) issued to Panosian and U.S. Pat. No. 2005/0263552 A1 (2005) issued to Panosian describes a utility belt attachment assembly that includes male and female connection elements. This prior art includes a variety of attachment assemblies. To remove an object requires gripping the top portion and lifting pouch or other member from holder. The release member is exposed and in some construction environments could be damaged or accidentally released.

U.S. Pat. No. 6,698,632 (2004) issued to Turner describes a tool carrying belt that requires the accessories to be attached with a flap that extends from the pouch and over the top edge of the belt to a mating piece of material. The strength of the hanging accessory piece would depend upon the durability of the mated material.

U.S. Pat. No. 6,662,373 B2 (2003) issued to Frank and U.S. Pat. No. 5,833,095 (1998) issued to Russell describe a male attachment element with male coupler units with swivelable head components to attach accessory pouches to a host element. The prior art as described in both patents would likely cause problems during use by interfering with storing or removing items from the pouch. It is also likely that users of the belt attachment system would strike the securing elements with their hands or tools during use. In both cases damage to the male elements could occur.

U.S. Pat. No. 6,216,931 B1 (2001) issued to Tranwinski describes a method of attaching pouches to a host member by using a multi-wire hook that is inserted into a host grommet. The prior art further describes how additional pouches are hung from previously hung pouches. This design depends upon the wire hooks not loosening and falling from the grommets during use. Storing the unused pockets could likely be problematic with the pouch hooks becoming tangled with tools and other detached pouches.

U.S. Pat. No. 20,040,226,972 (2004) issued to Cook describes a duty belt that has multiple attachment assemblies. One method uses a horizontal slide on the belt to receive accessories. Another embodiment of said invention uses vertical male slides to mate with the female member that is on the accessory tool or pouch. As with other prior art, the slide method could be obstructed with debris, preventing free movement of accessory during attachment. As in other prior art, to add a new accessory it would require removal of accessories that interfere with placement of additional ones. The latter prior art likely will have problems with the strength of attachment since the locking hook seems to be the element part that the accessory is hanging from. The prior art design appears bulky and likely will add material to the design.

U.S. Pat. No. D359,464 (1995) issued to Grasso describes a belt fastener that attaches a male and female element. U.S. Pat. No. 4,424,841 (1984) issued to Smith describes a utility bag attachment system that utilizes similar prior art. Though the attachment assembly works well generally for securing a belt around the waist, it is ill suited to hold vertical weight.

U.S. Pat. No. 4,747,527 (1988) issued to Trumpower describes an attachment system that uses both a small molded male and female assembly, as well as a hook and loop assembly similar to U.S. Pat. No. 7,011,241 (2006) issued to Godshaw. The patent issued to Trumpower employs small attachment elements that would be difficult to line up. And for single attachment points, the accessory would likely swing freely.

U.S. Pat. No. 6,824,028 B2 (2004) issued to Mutal describes a holder assembly for a hand-held device that includes a main body for holding said device. The main body has a groove that accommodates a slide bracket. Included in the design are a number of moving parts to secure the connection. Though it is a workable design, it is however prone to the accumulation of debris and other residue that would eventually interfere with its use.

U.S. Pat. No. 5,915,610 (1999) issued to Russell describes a carpenter's tool holder that is supported from a wearer's waist belt. The prior art design is very limiting to few tools and use.

U.S. Pat. No. 2007/0205235 A1 (2007) issued to Knight describes a utility belt that has a first strip of material that forms a belt, and a second strip of material that has partial loops for the connection of one or more items. The prior art design is very limiting to few tools and use.

U.S. Pat. No. 6,213,365 B1 (2001) issued to Stocke describes a painter's utility belt that has a fixed design for positioning painter tools. The prior art design is very limiting to few tools and use.

U.S. Pat. No. 20090145866 (2009) issued to Panosian uses a large hanger base for wall mounting, but does not address a solution for attaching accessory pouches to a belt. The hanger element of the attachment assembly would not be comfortable for any use where a belt connection would be required.

U.S. Pat. No. 4,877,167 (1989) issued to McNemar describes a retention system particularly adapted for divers, and typically requires lanyards to secure members that have been removed from the host member. This prior art is not suitable for utility belts.

In conclusion, insofar as I am aware, there is no prior art that has been formally developed that provides for an efficient connection assembly for solving the problem of a modular component system for managing accessories attached conveniently to a host member.

### SUMMARY OF INVENTION

The primary objective of the present invention is to provide a carrying device system for various kinds of small tools and supplies accessory members that overcomes the disadvantages of prior art systems.

It is another object of the invention to provide an accessory attachment assembly for a utility belt system or other embodiments, that is simple in construction and economical to manufacture.

It is still another object of the invention to provide an accessory attachment assembly for a utility belt system or other embodiments, that is easy and convenient to use.

It is yet another object of the invention to provide an attachment assembly for a utility belt system or other embodiments that is modular and can be highly customized to the preferences of the user.

It is still another object of the invention to provide an attachment assembly for a utility belt system which can be conveniently used by allowing the user to quickly and easily release a pouch or receptacle with the fingers of the user.

It is also the object of the invention to provide a receiver plate that would have a narrow attachment area to said host member. This is especially important when the host member is a belt, so as not to interfere with the flexibility and comfort for the wearer.

It is a further object of the invention to provide an attachment assembly for a utility belt system that allows the pouches or receptacles supported thereby to be easily and conveniently separated and lifted off a utility belt system or other embodiments.

It is still a further object of the invention to provide an attachment assembly for a utility belt system in accordance with the previous objects, one that allows a user to add, remove or interchange pouches or object-receptacles with ease and convenience substantially independently of the sizes, shapes or weights of such pouches or receptacles.

The present invention solves the tool and supply storage and use problem associated with prior-art pouches by attaching the pouch to the host member using a rigid and slidable attachment assembly. The fastener assembly secures the removable tool or supply pouch to the host member in the same manner as though it was permanently attached. The pouches are thus better retained, and access to pouch and tool contents is more predictable.

### DETAILED DESCRIPTION OF INVENTION

The fastener assembly is comprised of two members; a male receiver plate and a female attachment device.

The plate member is attached to a host member, such as a belt, tool box, bucket organizer, work bench wall or any other area where tools and supplies would be stored.

The attachment device member is attached to an accessory member.

The accessory member is used to hold tools or materials. Examples of an accessory member could be a nail/screw pouch, tool holder, cell phone holder, tape measure holder or any other embodiments that would serve the user for organization and storage. It should be understood, however, that there is no intention to limit the invention to the specific accessory members listed prior, but, on the contrary, the invention is to cover all forms of accessories, fitted with an attachment device, that could be attached to a host member, fitted with a plate member.

Various types of fastening devices have long been available for fastening two objects together. The present invention overcomes the limitations of prior-art, by attaching a vertical receiver plate member to any host member suitable for attaching an accessory member to. In any case, the plate member is designed to mate with the attachment device member, so as to permit the accessory member to be readily attached and detached, and to operate as though the members were permanently joined.

The plate member of the present invention is designed to accept the attachment device member from either end. This provides for flexible use, since it does not matter which end of the plate member is ‘up’. If the plate members are installed on a belt, the user can wear the belt in either direction, left or right buckle assembly, since the plate member design is such that either end will mate with the attachment device member.

If the accessory member is a pouch, the plate member may be installed along the bottom of the pouch ‘in series’. This consecutive attachment can be repeated several times, such that a plurality of pouches are suspended from a single pouch location on either the belt or other embodiment. This not only allows greater flexibility and capacity when using a work-belt, but also provides for several pouches to be hung under a single label on wall.

The plate member size is of a defined dimension and the said member is attached to the host member with either two ‘chicago’ binder screws or rivets. Also known as binding posts or screw posts, they are available in metal or plastic, are very durable and provide secure attachment. The screws or rivets are ‘flush-mounted’ and vertically aligned in plate member to prevent interfering with the docking of the attachment device member.

The plate member has a wider connecting side, beveling down to a narrower host member attachment base. The screw or rivet passes through the entire plate member, adding additional strength when the plate member is fixed to the host member.

Further, a reinforcement plate can be added to either the attachment device or plate member, on the opposite side of the hosting material. The addition of this plate will increase the amount of surface area the screws or rivets are fixed to. Thus, a much stronger mounting of either member is derived.

The attachment device member has a vertical slot that is open from the bottom. The shape of the slot is congruous with the receiver plate member. The mating of the two members provides for a strong and secure coupling.

The entrance area of the attachment device member slot is curved on both sides in such a way as to provide smooth and quick docking of the attachment device member to the plate member.

The known utility belt fasteners frequently make it difficult, if not impossible, to detach or attach the pouch, especially if one has to do this with one hand while the other hand is occupied. In addition, some of the known fastener assemblies do not provide for the prevention of accidental detachment of pouches from the receiver member.

This invention includes a latch tang on the attachment device element. When the attachment device member has been fully docked into position on the plate member, the barbed end of the tang of the attachment device member clips to the bottom of the plate member, securing the attachment device member to the plate member. Another embodiment of the latch tang could include a separate unattached tang member, rather than a fully incorporated member as shown.

To remove the attachment device member, the user simply reaches below the plate member, and depresses the tang toward the accessory to release the barb from the bottom of the plate member. The attachment device member is then pulled vertically to fully detach from the plate member.

The inside contact surface of the barb is angled to prevent accidental detachment by gaining holding strength when the plate member is moved in the direction opposite of attachment to the plate member.

Some of the known utility belt fasteners have release features exposed above the belt. The attachment device member of this invention has the tang positioned at the bottom of the attachment device member to prevent damage to tang and accidental release. Said positioning improves integrity of attachment while not sacrificing convenience.

The width of the barb, is greater than the diameter of the screw or rivet hole of the plate member in order to eliminate possible snagging during attachment or detachment.

These and other objects of the present invention will become readily apparent upon further review of the following specification and drawings. A more complete understanding of the invention will be afforded to those skilled in the art, as well as a realization of additional advantages and objects thereof, by a consideration of the following detailed description of the preferred embodiment.

### BRIEF DESCRIPTION OF THE DRAWINGS

Various other objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a perspective exploded view of the two components of the connection system.

FIG. 2 is a perspective of the two components of the connection system docked together.

FIG. 3 is a Front and Back elevation of the attachment device installed on a utility pouch accessory.

FIG. 4 is a side elevation cross-section of the two components of the connection system during docking.

FIG. 5 is a perspective of an accessory pouch that has the attachment device installed and docking to a plate element that is installed on a wall mounted host member.

FIG. 6 is a perspective of a utility belt host member containing plurality of plate members with defining spaces that provides docking opportunity to accessory members containing attachment devices.

FIG. 7 is a perspective of a utility bucket host member containing plurality of plate members with defining spaces that could provide docking opportunity to accessory members containing attachment devices.

FIG. 8 includes a Front and Back elevation of the attachment device.

FIG. 9 is a perspective of an accessory pouch member that has an attachment member installed in series to another host pouch member that has a receiver plate member installed on the pouch.

FIG. 10 is a side elevation cross-section of the two components of the connection system docked to illustrate the relative height of the top surfaces.

FIG. 11 is a side elevation cross-section of the receiver plate member with ‘chicago’ binder screws installed and not yet secured to fix the plate member to a host member.

FIG. 12 is a side elevation cross-section of the receiver plate member with ‘chicago’ binder screws installed and secured, thereby fixing the plate member to a host member.

FIG. 13 is a perspective exploded view of the attachment device that includes the ‘chicago’ binder screws and the optional reinforcement plate.

FIG. 14 is a perspective exploded view of the plate member that includes the ‘chicago’ binder screws and the optional reinforcement plate.

### DESCRIPTION OF THE PREFERRED EMBODIMENTS

While the invention is susceptible of various modifications and alternative constructions, certain illustrated embodiments have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

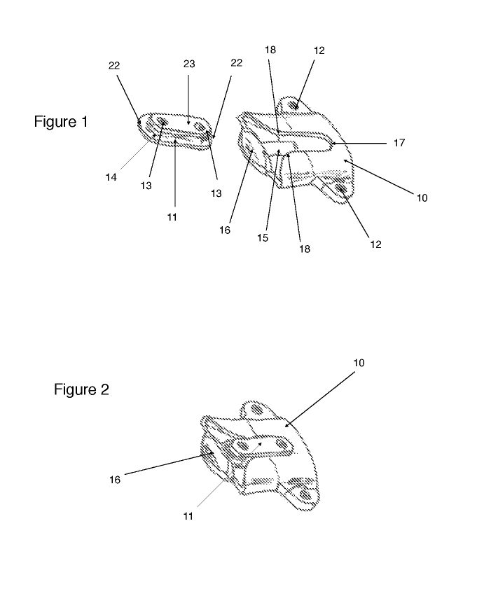

Referring now to the Figures, in which similar or identical parts are identified by the same reference numerals throughout, and first referring to FIG. 1, a female attachment device in accordance with the present invention is generally referred to by the reference numeral 10 and a male receiver plate in accordance with the present invention is generally referred to by the reference numeral 11.

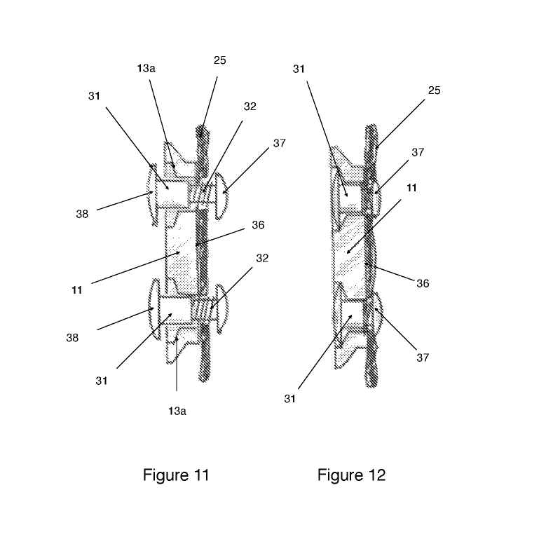

To fix attachment device 10 to an accessory member, or fix receiver plate 11 to a host member, a variety of options exist. The invention requires flush mounted screws or rivets for attaching members. If using screws, a female-male assembly commonly known as tee-nuts or ‘chicago’ binder screws can be used. Also known as binding posts or screw posts, they are available in metal or plastic, are very durable and provide secure attachment. FIGS. 11 and 12 illustrate the use of ‘chicago’ screws 31 and 32 to attach plate member 11 to a belt host member 25.

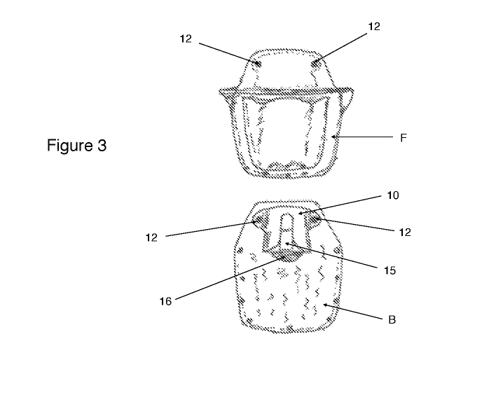

Further, the attachment device 10 in FIG. 1 includes holes 12 for flush-mounted ‘chicago’ screws or rivets. These screws or rivets would attach member 10 to an accessory member as is shown in FIG. 3.

To assist in docking member 11, the entry of the slot of device 10 is rounded on both sides 18. And when fully docked into position as shown in FIG. 2, plate member 11 end portion 22 is rounded to substantially conform with member 10 slot end 17.

Further, both ends 22 of plate member 11 are equally rounded, thereby allowing docking from either end.

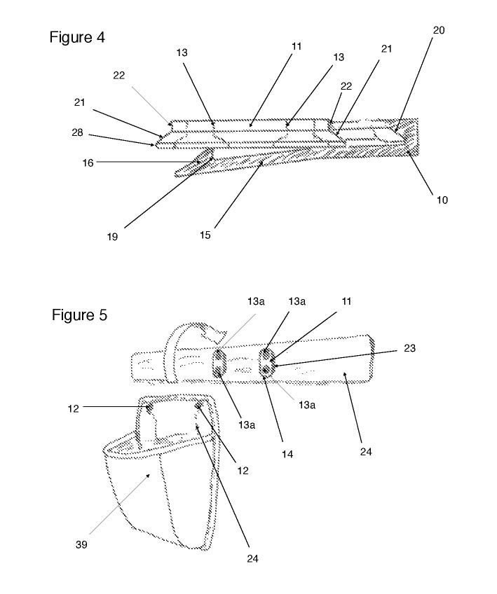

FIG. 4 further illustrates the cross-section of plate member 11 docking to attachment member 10. Until fully docked into position, the tang 15 is deflected away from plate member 11 by contact with barb 16. When plate member 11 is fully docked and barb 16 is located past the end 22 of plate member 11, tang 15 will return to the original position.

Further, when plate member 11 is fully docked, barb 16 will resist accidental detachment due to the angled surface of side 19 of barb 16. To detach plate member 11, the user depresses barb 16 until the top of barb 16 is even with or below the slidable surface of plate member 11.

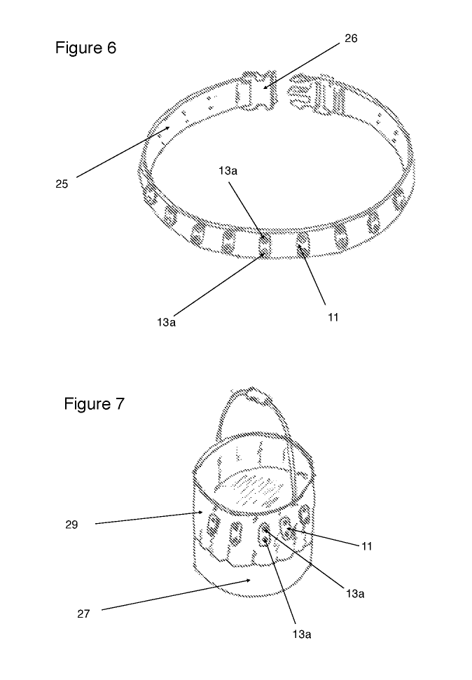

Plate member 11 is attached to a host member with flush-mounted ‘chicago’ binder screws or rivets using holes 13. Examples of a host member include a wall attachment bar 24 as shown in FIG. 5, a belt 25 as shown in FIG. 6 or a utility bucket skirt 29 as shown in FIG. 7.

Holes 13 of plate member 11, on the side opposite the host member, are counter-sunk 13a to eliminate interfering when docking plate member 11 to attachment member 10.

As shown in FIG. 4, attachment member 10 is congruous with receiver plate member 11. When fully docked, the leading end 21 of plate member 11 will mate congruently with surface 20 of attachment member 10, thereby adding additional strength to the connection assembly. The congruous slot design of plate member 11 and attachment member 10, respectfully 21 and 20, is on all attachment sides of both members.

An important feature of this invention is to provide a system that allows for easy attachment and detachment of accessories to any host member. Host member(s) that have plate member(s) 11 installed, in either single or plurality, are able to receive any accessory that has attachment device 10 installed.

In FIG. 6 the host member is a belt 25. Installed on belt 25 are plurality of plate members 11. The user of the invention is thereby able to attach accessory members to belt 25 by docking attachment member 10 to plate members 11.

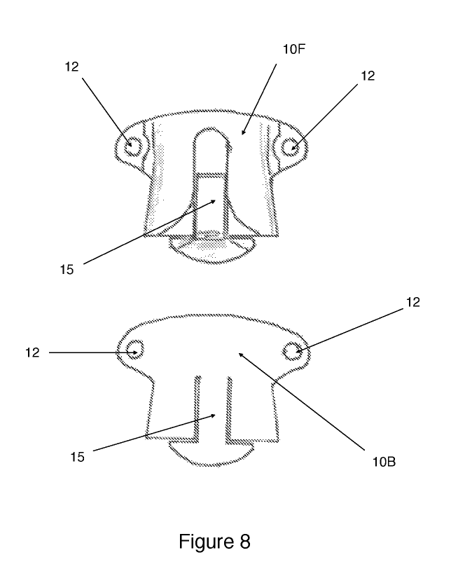

In FIG. 8, both sides of the attachment device 10 are illustrated. Side 10F is the FRONT side that includes the congruent cavity for docking with plate member 11. Further, side 10B is the flat BACK side that is fixed against accessory member(s). Further, FIG. 8 illustrates tang 15 construction on attachment member 10B. Another embodiment of the tang member would be an installable tang, rather than 15 as illustrated.

In FIG. 7 the host member is a manufactured skirt 29 installed on a large bucket 27. Fixed to skirt 29 are plurality plate members 11. As in FIG. 6, the user of the invention is thereby able to attach the accessory members to skirt 29 by docking attachment member 10 to plate member(s) 11.

Another embodiment of the invention is shown in FIG. 5. This figure illustrates installed plate members 11 to a host bar 24. As in FIG. 6, the user of the invention is thereby able to attach the accessory members to host bar 24 by docking attachment member 10 to plate members 11. In this embodiment host bar 24 could be attached to a vertical work bench or work trailer wall.

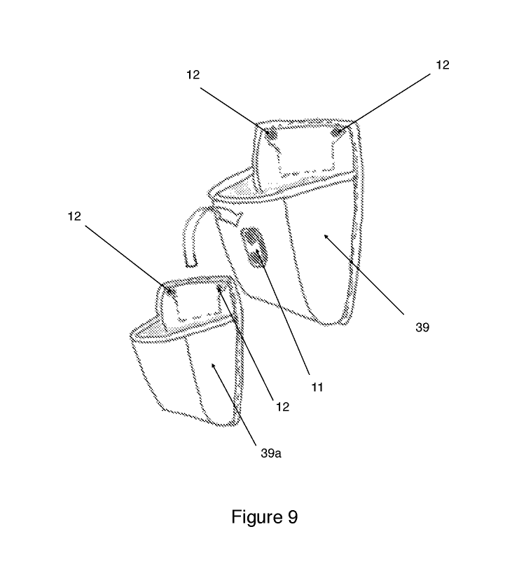

FIG. 9 illustrates the installation of receiver plate member 11 to a pouch accessory member 39, thereby providing for the attachment in series of a pouch accessory 39a to ‘host’ accessory 39. Therefore, any accessory with an attachment member 10 installed is able to attach in series with to another accessory member that includes receiver member 11.

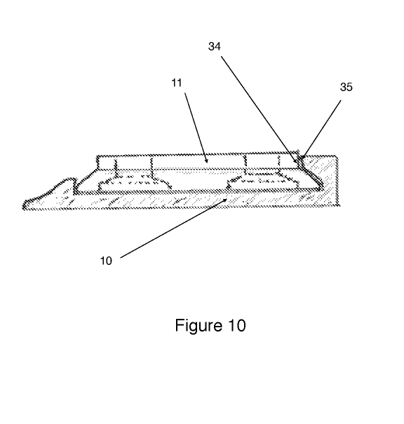

For ease of docking accessory attachment member 10 to receiver plate member 11, without resistance, it is important for the width of receiver plate 11 to be greater than the height of attachment member 10 slot area. FIG. 10 illustrates that plate member 11 side 34 dimension is such that plate member 11 surface 23 is higher than attachment member 10 surface 35. If this distance were equal or less, thereby creating a flush overall surface combination of both plate 11 and attachment 10 members, docking of the two members would be adversely impacted.

FIGS. 11 and 12 cross-sections illustrate the connection of plate member 11 with a belt host member 25. Further, FIG. 11 illustrates the unsecured ‘chicago’ binding posts 31 and screws 32, in preparation of fixing plate member 11 to host member 25. Prior to placement of any plate member 11 to host member 25, it is required that two holes are drilled or punched through host member 25 that are of same general separation as holes 13 in plate member 11.

Further, FIG. 12 illustrates fixed plate member 11 to host member 25 by the rotation of screws 32 until the top 37 of screw 32 is firmly secured to host member 25, and binding post top 38 is seated in plate member's 11 countersunk hole 13a. The attachment of all members in FIG. 12 is completed when screw 32 is tightened into binding post 31. Thereby, resulting with the top surface 38 of binding post 31 being submerged into hole 13a, thus preventing resistance to the sliding surface of plate member 11 when docking with attachment member 10.

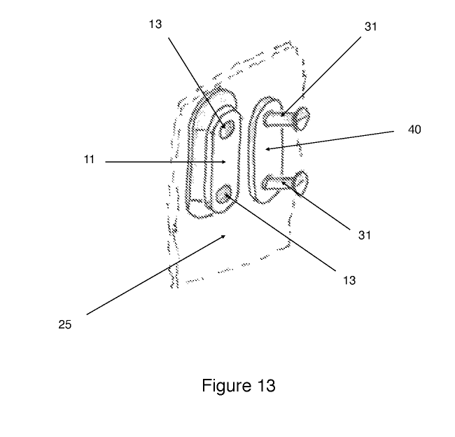

FIG. 13 illustrates the assembly of the receiver plate that includes the reinforcement plate 40 and ‘chicago’ binder screw elements 31, 32.

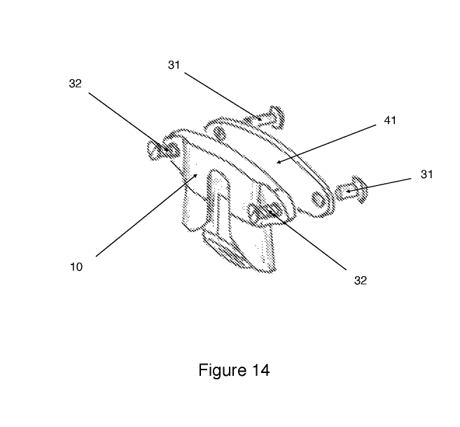

FIG. 14 illustrates the assembly of the attachment device that includes the reinforcement plate 41 and ‘chicago’ binder screw post 31.

### REFERENCE NUMERALS

10 attachment device
10B back side elevation of attachment device
10F front side elevation of attachment device
11 receiver plate
12 screw or rivet hole in attachment device
13 screw or rivet hole in receiver plate
13a counter-sunk part of hole 13 in receiver plate
14 angled surface of docking area of receiver plate
15 tang on attachment device
16 barb on tang of attachment device
17 rounded end of slot on attachment device
18 rounded side of slot on attachment device
20 angled area of attachment plate
21 angled area of receiver plate
22 rounded end of receiver plate
23 surface of receiver plate nearest host member
25 belt accessory
26 belt buckle
27 bucket accessory
29 manufacturer skirt for bucket accessory
31 binder post
32 binder screw
36 attachment surface of receiver plate under host member belt
37 top surface of binder screw
38 top surface of binder post
39 pouch accessory
39a pouch accessory for attachment in series
40 receiver plate's optional reinforcement plate
41 attachment device's optional reinforcement plate
B back elevation of pouch accessory
F front elevation of pouch accessory

### Operation

In operation one would use the attachment assembly in connecting or fixing accessories to a hosting member that would have a receiver plate installed. The hosting member could include a belt, work bench wall, tool box, bucket organizer, construction trailer wall, pouch, device holder, backpack or any other embodiment that would benefit from the attachment of accessories. There is no intention to limit the invention to specific accessory members, but, on the contrary, the invention covers all forms of accessories, fitted with an attachment device, that could be attached to a host member, fitted with a receiver plate member.

When an attachment device is installed on an accessory and a receiver plate is installed on a host member, the user can:

(1) choose an accessory to attach to the host member
(2) choose an accessory to attach in series to a host member that is also an accessory
(3) choose an accessory to attach in storage for later use on a wall mounted receiver plate
(4) rearrange attached accessories on a host member
(5) detach accessories from a host member

Further, the user may manually install or relocate hosted receiver plates in areas where the hosted site would be convenient.

And further, the user may manually install attachment devices on accessories that the user would deem an accessory that did not previously include an attachment member.

And further, the user may employ a reinforcement backing plate when fixing the attachment device or the receiver plate to either the member's accessory or host element, respectively.

1. A connection system for allowing interchangeable connection of a plurality of accessories to a belt or other hosting element comprising:
a plurality of vertically disposed receiver plates connected to said belt or hosting element, said plates with defining spaces there between, said plates and said spaces configured to receive and hold a compatibly configured slotted attachment device upon said belt or hosting element.

2. The connection system of claim 1 further comprises two vertically orientated screws or rivets, configured to hold said plates upon said belt or other hosting element.

3. The connection system of claim 1 further comprises two horizontally orientated screws or rivets, configured to hold said slotted attachment device upon said variety of accessories.

4. (canceled)

5. (canceled)

6. (canceled)

7. The connection system of claim 1 wherein said slotted attachment device slot further includes an opening to said slot with a rounded and sloped entry thereby providing smooth docking with said plate.

8. The connection system of claim 1 wherein said slotted attachment device further comprising a tang with an angled barb at an end of said tang configured to hold and secure said slotted attachment device upon said vertical plates.

9. (canceled)

10. Said tang of claim 8 further is located along a central axis of said attachment device on a face opposite said slot of said attachment device whereby said location protects said tang means from breakage and provides an enlarged means for holding said attachment device conveniently.

11. (canceled)

12. The connection system of claim 1 wherein release of said slotted attachment device from said plate is achieved by depressing said tang until said barb is free of said plate.

13. Said hosting element of claim 1 includes a wall organizing system comprising a generally elongate track; means for attaching said track to a wall or other substantially vertical surface thereby having said plates fixed so that said accessories are docked.

14. Said wall organizing system of claim 13 further includes any attachment of said plates with defining spaces there between for docking of said accessories.

15. Said accessories of claim 1 are selected from the group consisting of framer's pouch, carpenters pouch, electrician's pouch, tape pouch, first aid pouch, personal pouch, personal pouch, drink pouch, nail gun pouch, cable pouch, fastener pouch, pliers pouch, driver pouch, drill pouch, radio pouch, bit pouch, lunch box, thermos are supported on said belt.

16. (canceled)

17. The connection system of claim 1 further includes optional reinforcement plates installed on an opposite surface side of attached members.

18. (canceled)
